(19) United States
(12) Patent Application Publication
(10) Pub. No.: US 2016/0322169 A1
(43) Pub. Date: Nov. 3, 2016

(54) TUNGSTEN POWDER, ANODE BODY FOR CAPACITORS, AND ELECTROLYTIC CAPACITOR

(71) Applicant: SHOWA DENKO K.K., Tokyo (JP)

(72) Inventors: Kazumi NAITO, Tokyo (JP); Ryuichi MITSUMOTO, Tokyo (JP)

(73) Assignee: SHOWA DENKO K.K., Tokyo (JP)

(21) Appl. No.: 15/106,012

(22) PCT Filed: Oct. 30, 2014
(86) PCT No.: PCT/JP2014/078950

§ 371 Date: Jun. 17, 2016

(30) Foreign Application Priority Data
Dec. 20, 2013 (JP) 2013-264039

(51) Int. Cl. H01G 9/042; H01G 9/052

(52) U.S. Cl. CPC H01G 9/042; H01G 9/0525

(57) ABSTRACT

A tungsten powder for an electrolytic capacitor having good leakage current (LC) characteristics, which powder contains germanium element only in the particle surface region and having a germanium element content of 0.05 to 7 mass %. The tungsten powder preferably has a volume average diameter of the primary particle of 0.1 to 1 μm; the germanium element is localized in a region from the particle surface to a depth of 50 nm inside the particle; the tungsten powder contains at least one member selected from tungsten silicide, tungsten carbide, tungsten boride, and tungsten containing nitrogen solid solution only in the particle surface region; the content of phosphorus element is 1 to 500 ppm by mass; and the oxygen content is 0.05 to 8 mass %.

### TECHNICAL FIELD

The present invention relates to a tungsten powder, an anode body using the same, and an electrolytic capacitor using the anode body.

### BACKGROUND ART

With the progress of small-size, high-speed and lightweight electronic devices such as cellular phones and personal computers, the capacitor used for these electronic devices is demanded to have a smaller size, a larger capacitance and a lower equivalent series resistance (ESR).

As an example of such a capacitor, an electrolytic capacitor has been proposed, which capacitor is produced by anodically oxidizing a sintered body (anode body) obtained by sintering valve-acting metal powder such as tantalum which can be anodized to form a dielectric layer made of the oxide of the metal on the surface of the sintered body.

The electrolytic capacitor using tungsten as a valve-acting metal and employing a sintered body of the tungsten powder as an anode body can attain a larger capacitance compared to the electrolytic capacitor obtained with the same formation voltage by employing an anode body of the same volume using the tantalum powder having the same particle diameter but have a problem of high leakage current (LC).

The present applicant found that the problem of the LC characteristics can be solved by using a tungsten powder comprising a specific amount of tungsten silicide in the particle surface region, and proposed a tungsten powder comprising tungsten silicide in the particle surface region and having a silicon content of 0.05 to 7 mass %; an anode body comprising the sintered body of the tungsten powder; an electrolytic capacitor; and a production method thereof (Patent Document 1; WO 2012/086272; US 2013/277626 A1).

### PRIOR ART

### Patent Document

Patent Document 1: WO 2012/086272 (US 2013/277626 A1)

### DISCLOSURE OF INVENTION

### Problems to be Solved by the Invention

An objective of the present invention is to provide a tungsten powder capable of attaining superior LC characteristics while maintaining a large capacitance in an electrolytic capacitor comprising as an anode body a sintered body of tungsten powder used as a valve-acting metal; an anode body using the tungsten powder; and an electrolytic capacitor using the anode body as an electrode.

### Means to Solve the Problem

The present inventors have found that the above-mentioned problem can be solved by using a tungsten powder, in which tungsten is combined with germanium element in at least a part of the particle surface region so that the germanium element content in the tungsten powder falls in a specified range, and have accomplished the present invention.

That is, the present invention relates to the tungsten powder, the anode body of the tungsten powder, the electrolytic capacitor, the method for producing the tungsten powder, and the method for producing the anode body for a capacitor as described below.
[1] A tungsten powder, comprising germanium element only in the particle surface region and having a germanium element content of 0.05 to 7 mass %.
[2] The tungsten powder as described in [1] above, wherein at least part of the germanium element forms a compound with tungsten element.
[3] The tungsten powder as described in [2] above, wherein the compound is WGe₂ or W₅Ge₃.
[4] The tungsten powder as described in any one of [1] to [3] above, wherein the volume average diameter of the primary particle is 0.1 to 1 μm.
[5] The tungsten powder as described in any one of [1] to [4] above, wherein the particle surface region is a region from the particle surface to a depth of 50 nm inside the particle.
[6] The tungsten powder as described in any one of [1] to [5] above, comprising at least one member selected from tungsten silicide, tungsten carbide, tungsten boride, and tungsten containing nitrogen solid solution only in the particle surface region.
[7] The tungsten powder as described in any one of [1] to [6] above, wherein the oxygen content is 0.05 to 8 mass %.
[8] The tungsten powder as described in any one of [1] to [7] above, wherein the content of elements other than each element of tungsten, germanium, silicon, nitrogen, carbon, boron, phosphorus and oxygen is 0.1 mass % or less.
[9] The tungsten powder as described in any one of [1] to [8] above, wherein the tungsten powder is a granulated powder.
[10] The tungsten powder as described in any one of [1] to [9] above, which is a powder for an electric capacitor.
[11] An anode body for a capacitor obtained by sintering the tungsten powder described in any one of [1] to [10] above.
[12] An electrolytic capacitor, which is provided with a complex of a dielectric layer and an anode obtained by anode oxidation of the anode body described in [11] above, and a cathode formed on the dielectric layer.
[13] A method for producing the tungsten powder described in any one of [1] to [10] above by mixing germanium powder so that the germanium element content in the tungsten powder falls within a range of 0.05 to 7 mass %, and by allowing the mixture to react through heating under reduced pressure.
[14] The method for producing the tungsten powder as described in [13] above, wherein the heating temperature is from 1,000 to 2,600° C.
[15] The method for producing the anode body for a capacitor, comprising sintering the tungsten powder described in [9] above.

### Effects of Invention

The tungsten powder of the present invention makes it possible to produce a capacitor having good LC characteristics while maintaining a large capacitance compared to the case of using a conventional tungsten powder.

### MODE FOR CARRYING OUT INVENTION

A commercially available tungsten powder can be used as a tungsten powder serving as a material of the anode body. A tungsten powder having a smaller particle size is preferable. The tungsten powder having a smaller particle diameter than those of commercially available tungsten powder can be obtained by, for example, pulverizing the tungsten trioxide powder under hydrogen atmosphere; or reducing the tungsten acid and halogenated tungsten using a reducing agent such as hydrogen and sodium and appropriately selecting the reducing conditions.

Also, the tungsten powder can be obtained by reducing the tungsten-containing mineral directly or through several steps and by selecting the reducing conditions.

The tungsten powder of the present invention, which contains germanium element only in the surface region of the particles, can be obtained by, for example, mixing a germanium powder with a tungsten powder and heating the mixture under reduced pressure to allow it to react. The diameter of the germanium powder to be used is preferably 0.1 to 50 μm, more preferably 0.1 to 1 μm. It is possible to incorporate germanium element in the tungsten powder by using GeH₄ and Ge₂H₈ which is known as a raw material gas for a semiconductor. However, it is necessary to provide a facility exclusively for conducting the reaction or for eliminating hazard due to possibility of decomposition explosion. It results in high cost and is not preferable. In the case of using a germanium powder, germanium element enters from the surface of the tungsten particles and generally exists in the region within 50 nm inside the tungsten particle from the particle surface. The region in which the germanium element exists is the particle surface layer. As described above, the particle surface layer is generally to a depth of 50 nm inside the particle from the particle surface and the size of the region varies depending on the treatment conditions for incorporating germanium element. In the present invention, the expression “contain XX element (or compound) only in the particle surface region” does not require that 100% of the XX element (or compound) contained in the tungsten powder exists in the particle surface region but means that 95% or more of the XX element (or compound) exists in the region. Most of the germanium element exists in the tungsten particle surface region in a state of a solid solution but part of the germanium element exists as a germanium-tungsten compound such as WGe₂ and W₅Ge₃. The above-mentioned germanium element exists only in the particle surface region. Hence, the core of the primary particles remains as a highly-conducting metal tungsten, which suppresses the equal serial resistance of the capacitor anode body produced using the tungsten powder, which is preferable. The germanium element content in the tungsten powder can be adjusted by the germanium powder amount to be added.

As the germanium element content in the tungsten powder of the present invention, 0.05 to 7 mass % is preferable and 0.2 to 5 mass % is particularly preferable. By using a tungsten powder having a germanium element content within the range, an electrolytic capacitor having a high capacitance and good LC characteristics can be produced.

The reason why improve the LC characteristics of a capacitor are improved by using as an anode body a sintered body of a tungsten powder containing germanium element in the particle surface region in an amount of 0.05 to 7 mass % is not altogether clear. However, from the fact that germanium oxide is known as a synthesis catalyst of polyethylene terephthalate and the like, it is assumed that in the sintered body of a tungsten powder containing germanium element in an amount specified by the present invention, the germanium content exists in the form of W—O—Ge in the particle surface region functions as a catalyst at the time of forming a semiconductor layer on a dielectric layer. As a result, a denser semiconductor layer is formed in a wider area on the dielectric layer, thereby increasing the capacitor capacitance compared to the case of using a conventional tungsten powder.

When the germanium content is less than 0.05 mass %, the powder is not capable of imparting good capacitance characteristics to the electrolytic capacitors in some cases. When the germanium content exceeds 7 mass %, the tungsten powder contains too much germanium content and when an anode body for an electrolytic capacitor is obtained by sintering the powder and is subjected to chemical formation, the capacity of the formed dielectric layer may decrease in some cases.

The mixture of a tungsten powder and a germanium powder is reacted by heating under reduced pressure condition of 10⁻¹ Pa or less, preferably 10⁻³ Pa or less.

The reaction temperature is preferably 1,000 to 2,600° C. As the germanium particle diameter becomes smaller, the operation for incorporating germanium can be conducted at a lower temperature. When the reaction temperature is lower than 1,000° C., the operation for incorporating germanium takes a longer time. When the reaction temperature exceeds 2,600° C., germanium element evaporates more readily, and it requires maintenance of the high temperature vacuum furnace to deal with the issue.

The time for leaving the mixture to stand at a high temperature is preferably three minutes or more and less than two hours. The optimum conditions of temperature and time adjusted to the high temperature vacuum furnace to be used can be determined by analyzing the powder produced in a preliminary experiment.

Further, the tungsten powder may be the granulated one (hereinafter, the granulated tungsten powder may be referred to as the “granulated powder”). As a powder for an electrolytic capacitor, a granulated powder facilitates formation of fine pores in an anode body and is preferable.

Using each of the above-described ungranulated tungsten powders (hereinafter may be referred to as the “ungranulated powder”), the granulated powder further may the one in which the fine pore distribution is adjusted in the manner as JP-A-2003-213302 discloses on the case of a niobium powder.

As a form of the germanium powder to be used, the powder may be an aggregated product or a granular product. In light of miscibility with a tungsten powder, a germanium powder having a similar diameter size to that of a tungsten powder enables uniform mixing and is preferable. Part of the germanium element mixed with a tungsten powder combines with tungsten element in the surface region of the tungsten powder particles at the time of high temperature treatment under reduced pressure, and the rest of the element exists in the tungsten particle surface region in a state of a solid solution. Generally, the germanium content in the tungsten powder containing germanium element in the particle surface region is approximately equal to half of the germanium powder input at the time of high temperature treatment under reduced pressure. Therefore, the germanium powder input is adjusted to twice the amount of the germanium element content in the target tungsten powder (0.05 to 7 mass %, preferably 0.2 to 4 mass %) as an index so that the tungsten powder has a germanium element content of 0.05 to 7 mass % (preferably 0.2 to 4 mass %), and a tungsten powder is mixed and reacted with a germanium powder.

A tungsten powder suitable as a raw material, that is, a tungsten powder having a smaller particle diameter, can be obtained, by pulverizing the tungsten trioxide powder under hydrogen atmosphere using a pulverizing media (The raw material tungsten powder may be referred to as “a coarse powder” in a simple term). As the pulverizing media, a pulverizing media made of the metal carbide such as tungsten carbide and titanium carbide is preferable. In the case of using these metal carbides, fine fragments of the pulverizing media is less likely to be mixed into the powder. Preferred is a pulverizing media made of tungsten carbide.

A granulated product of each of various tungsten powders can be obtained by sintering each of powders at a high temperature under reduced pressure to make it in a granulated or an agglomerated form, cooling the powder to room temperature, and then pulverizing the powder with a hammer mill and the like. The pressure, temperature condition, time for leaving the powder to stand, and the like in this case may be the same as those in the case for obtaining a tungsten powder containing germanium element in the particle surface region at a high temperature under reduced pressure as described above. However, a temperature of about 100 to 300 degrees higher than that in the case of obtaining a tungsten powder containing germanium element in the particle surface region is preferred since a granulated powder having strength can be obtained.

The granulated powder can be obtained by adding at least one member of liquid such as water and liquid resin to the raw material powder so as to be made into the granules having an appropriate size; and sintering the granules by heating under reduced pressure. The reduced-pressure condition and the high temperature standing condition can be determined within the above-mentioned ranges by a preliminary experiment. If there are no agglomerations of the granules with each other after the sintering, there is no need for pulverization.

Such granulated powder can be classified by a sieve into particles each having a similar diameter. The volume average particle diameter of the granulated powder within a range of preferably 50 to 200 μm, more preferably 100 to 200 μm, is suitable because the powder can smoothly flow from the hopper of the molding machine to a mold at the time of forming the powder as an anode body for a capacitor.

In particular, a tungsten powder containing germanium element in the particle surface region having a volume average particle diameter of 0.1 to 1 μm, preferably 0.1 to 0.3 μm can increase the capacitance of a capacitor made from the granulated powder.

In the case of obtaining such a granulated powder, by adjusting the above-described primary particle diameter so as to make the specific surface area (by BET method) of the granulated powder fall within a range of preferably 0.2 to 20 m²/g, more preferably 1.5 to 20 m²/g, the capacitance of an electrolytic capacitor can be further increased and it is desirable.

As the tungsten powder containing germanium element in the particle surface region of the present invention, a tungsten powder which further contains at least one member selected from tungsten silicide, tungsten carbide, tungsten boride, and tungsten containing nitrogen solid solution, can be suitably used.

The tungsten powder in which the particle surface region is silicified can be obtained by, for example, mixing the silicon powder well into the tungsten powder and allowing the mixture to react by heating under reduced pressure. In the case of using this method, the silicon powder reacts with the tungsten from the surface of the tungsten particles and tungsten silicide such as W₅Si₃ is formed generally in the region within 50 nm inside the tungsten particle from the particle surface. The tungsten silicide content can be adjusted by the silicon amount to be added. In any kind of tungsten silicide, its content can be adjusted based on the silicon content. The silicon content of the tungsten powder of the present invention is preferably 0.05 to 7 mass %, and particularly preferably 0.2 to 4 mass %. The reduced-pressure condition is 10⁻¹ Pa or less, preferably 10⁻³ Pa or less. The reaction temperature is preferably 1,100 to 2,600 C°. The heating time is preferably three minutes or more and two hours or less. The operation for adding silicon element can be conducted at the same time as the operation for adding germanium element.

As an example of the method for allowing a nitrogen solid solution to be contained in various tungsten powders containing germanium element in the particle surface region, there is a method of placing the tungsten powders at 350 to 1,500° C. under reduced pressure and allowing a nitrogen gas to pass through for from several minutes to several hours.

A step of incorporating a nitrogen solid solution may be conducted at the time of the high-temperature treatment under reduced pressure for incorporating germanium element, or conducted prior to the step of incorporating germanium element. Further, the step of incorporating a nitrogen solid solution can be conducted at the time of producing a coarse powder, after the production of a granulated powder, or after the production of a sintered body. Thus, it is not specified when the step of incorporating a nitrogen solid solution is conducted during the production process of a tungsten powder, but it is preferable to allow the tungsten powder to have a nitrogen content of 0.01 to 1 mass % in an early stage of the production process. The treatment of incorporating a nitrogen solid solution can prevent excessive oxidation of the powder when the powder is handled in air.

As an example of the method of allowing carbon element to be incorporated in the particle surface region of various tungsten powders, there is a method of placing the tungsten powders at 300 to 1,500° C. under reduced pressure in a high temperature vacuum furnace using carbon electrodes for from several minutes to several hours. The carbonization is conducted so as to adjust the carbon content to 0.001 to 0.5 mass % by selecting the temperature and period of time. The time when the carbonization is conducted during the production process is the same as the above-mentioned timing of incorporating a nitrogen solid solution. When the nitrogen gas is introduced into the furnace with carbon electrodes under predetermined conditions, carbonization and incorporation of a nitrogen solid solution can be conducted simultaneously, which enables the production of the tungsten powder containing germanium element only in the particle surface region and containing silicon, carbon and a nitrogen solid solution.

As an example of the method for allowing boron element to be contained in tungsten powder containing germanium element in the particle surface region, there is a method of placing the boron element or a boron-containing compound as a boron source when granulating the tungsten powder. It is preferable to conduct the boronizing so that the boron content may be preferably 0.001 to 0.1 mass %. Good capacitance characteristics can be attained when the boron content is within the above-mentioned range. The time when the boronizing is conducted during the production process is the same as the above-mentioned timing of incorporating a nitrogen solid solution. When a powder subjected to the treatment of incorporating a nitrogen solid solution is put into a furnace having carbon electrodes, with a boron source placed in the furnace, and is granulated, it is possible to produce a tungsten powder containing germanium element, silicon, carbon, boron and a nitrogen solid solution in the particle surface region. When the boronizing is conducted so as to incorporate boron in a predetermined amount (to have a boron content of preferably 0.001 to 0.1 mass %), the LC characteristics are further improved in some cases.

At least one member of a silicified tungsten powder, a tungsten powder containing a nitrogen solid solution, a carbonized tungsten powder, and a boronized tungsten powder may be added to a tungsten powder containing germanium element in the particle surface region. It is the same in this case that each element of germanium, silicon, nitrogen, carbon and boron is preferably blended in an amount so that each content in the mixed powder satisfies the above-mentioned range.

In the above-described methods of silicification, carbonization and boronizing, each of tungsten powders containing germanium element in the particle surface region was subjected to the treatment. It is also possible to subject a tungsten powder to at least one of silicification, carbonization, boronizing and incorporation of nitrogen solid solution in advance, and to incorporate germanium element in the particle surface region of the resultant tungsten powder. It may be possible to subject a tungsten powder containing germanium element in the particle surface region to at least one of silicification, carbonization, boronizing and incorporation of nitrogen solid solution; and to mix the resultant tungsten powder with a single pure tungsten powder. Again, each element of germanium, silicon, nitrogen, carbon and boron is preferably blended in an amount so that each content in the mixed powder satisfies the above-mentioned range.

The oxygen content in the whole tungsten powder of the present invention is preferably 0.05 to 8 mass %, more preferably 0.08 to 5 mass %.

One of methods for controlling the oxygen content to 0.05 to 8 mass % is to oxidize the particle surface region of a tungsten powder, in which the particle surface region is subjected to at least one of silicification, carbonization and boronizing. Specifically, nitrogen gas containing oxygen is introduced when the powder is taken out from a high temperature vacuum furnace at the time of producing a coarse powder or a granulated powder of each tungsten powder. When the temperature at the time of being taken out from the high temperature vacuum furnace is lower than 280° C., the oxidization takes priority over the incorporation of nitrogen solid solution. By adjusting the partial pressure of oxygen in the mixed gas of oxygen and nitrogen and the mixed gas pressure in the furnace, a predetermined oxygen element content can be obtained. By making each of the tungsten powders have a predetermined oxygen content in advance, it is possible to reduce the deterioration due to the excessive oxidation caused by the formation of a natural oxide film having an uneven thickness during the subsequent processes for producing anode bodies for electrolytic capacitors using the powder. In cases where the oxygen content is within the above-mentioned range, the LC characteristics of the produced electrolytic capacitors can be kept better. In the case when nitrogen solid solution is not introduced in this process, an inert gas such as argon or helium may be used instead of the nitrogen gas. A step of incorporating oxygen in the tungsten powder is conducted preferably prior to the step of incorporating germanium. If an operation of incorporating oxygen in a tungsten powder containing germanium is conducted, it is highly likely that germanium element is reacted with oxygen element in the surface region of the tungsten particles, thereby generating germanium oxide, and most of the germanium oxide elutes off in the subsequent chemical conversion treatment. It will reduces the effect of the present invention and is undesirable.

The phosphorus element content in the tungsten powder of the present invention is preferably from 1 to 500 ppm by mass.

As an example of the methods for incorporating the phosphorus element in an amount of from 1 to 500 ppm in the tungsten powder containing germanium in the particle surface region, in which at least one of silicification, carbonization, boronizing, oxidation and incorporation of a nitrogen solid solution is conducted on at least a part of the particle surface region, there is a method of producing a powder containing phosphorus by placing phosphorus or a phosphorus compound as a phosphorus source in a high temperature vacuum furnace at the time of producing a coarse powder or a granulated powder of each tungsten powder. It is preferable to incorporate phosphorus in the tungsten powder so as to make the phosphorus content within the above-mentioned range by controlling the amount of the phosphorus source and the like because the physical breakdown strength of the anode bodies produced thereof can be improved in some cases. When the phosphorus content falls within the range, LC characteristics of the manufactured electrolytic capacitor are further improved.

To attain better capacitance characteristics in the tungsten powder containing germanium in the particle surface region, it is preferable to keep the total content of impurity elements other than each element of germanium, silicon, nitrogen, carbon, boron, oxygen and phosphorus in the powder to 0.1 mass % or less. In order to keep the content of these elements to the above-mentioned value or lower, the amount of the impurity elements contained in the raw materials, a pulverizing member to be used, containers and the like should be kept low.

An anode body for a capacitor can be obtained by sintering the tungsten powder of the present invention. Further, by giving a structure comprising a composite of an anode and a dielectric layer obtained by anodizing the anode body, and a cathode formed on the dielectric layer, an electrolytic capacitor is fabricated.

### EXAMPLES

The present invention is described below by referring to Examples and Comparative Examples, but the present invention is not limited thereto.

In the present invention, the measurement of the particle diameter and the specific surface area and elemental analysis were carried out by the methods described below.

The volume-average particle diameter was measured by using HRA9320-X100 manufactured by Microtrac Inc. and the particle size distribution was measured by the laser diffraction scattering method. A particle size value (D₅₀; μm) when the accumulated volume % corresponded to 50 volume % was designated as the volume-average particle size. The diameter of the secondary particles is to be measured by this method. However, since a coarse powder generally has good dispersibility, the average particle diameter of the coarse powder measured by the above measuring equipment can be regarded almost as a volume-average primary particle diameter.

The specific surface area was measured by the BET method by using NOVA2000E (manufactured by SYSMEX).

For the elemental analysis, ICP emission spectrometry was performed by using ICPS-8000E manufactured by Shimadzu Corporation.

### Example 1

A coarse powder of tungsten having an average particle diameter of 0.5 μm and a BET specific surface area of 0.3 m²/g was obtained by reducing tungsten acid with hydrogen at 980° C. Into the powder, separately prepared 9.6 mass % of commercially-available germanium powder (average particle diameter: 1 μm) was mixed. The mixture was put in a container made of tungsten and was left to stand in a vacuum heating furnace with molybdenum electrodes under 3×10⁻⁴ Pa at 1,320° C. for 40 minutes and cooled to room temperature, and the pressure was returned to ordinary pressure. Subsequently, the powder was pulverized by using a hammer mill and classified with a sieve with openings of 320 μm to thereby obtain a tungsten granulated powder. The obtained granulated powder had an average particle diameter of 120 μm and a specific surface area of 0.2 m²/g. As a result of the elemental analysis of the obtained granulated powder, the powder contained 4.8 mass % of germanium, 0.97 mass % of oxygen, and each of other impurity elements in an amount of 350 ppm by mass or less.

### Examples 2 to 5 and Comparative Examples 1 to 3

A tungsten granulated powder was obtained as in the same manner to that of Example 1 except that the blending quantity of germanium was changed. The average particle diameter and the specific surface area of the powder in each example were similar to those of the powder in Example 1. The germanium content and the oxygen content in the granulated powder obtained in each of examples are shown in Table 1, and the content of any other impurity element was 350 ppm or less.

### Example 6

Each of a commercially-available tungsten trioxide powder, a pulverizing media of 25 times the mass of the tungsten trioxide powder (tungsten carbide balls having a diameter of 1 mm) and water were put in a pulverizer “ATTRITOR” manufactured by Mitsui Mining Co., Ltd. so that the solid materials are immersed in water. The powder was pulverized at 700° C. in a hydrogen stream for five hours.

After removing the pulverizing media, the water was evaporated to thereby obtain a coarse powder of tungsten having an average particle diameter of 0.3 μm and a specific surface area of 2.3 m²/g. Next, a commercially-available germanium powder (average particle diameter: 0.2 μm) was added thereto so that the mixture contains 7.2 mass % of germanium and mixed well. The resultant powder was placed in a high-temperature vacuum furnace and left to stand under 7×10⁻⁴ Pa at 1,360° C. for 40 minutes. In course of cooling, nitrogen gas was introduced in the furnace at 1,000° C. so as to adjust the pressure in the furnace to 10 kPa and the powder was kept therein for 20 minutes. Lastly the pressure in the furnace was returned to ordinary pressure with nitrogen gas and the powder was taken out of the furnace. Subsequently, the powder was pulverized with a hammer mill, classified with a sieve having openings of 320 μm to obtain a granulated tungsten powder. The obtained granulated powder had an average particle diameter of 100 μm and a specific surface area of 1.6 m²/g and contained 3.6 mass % of germanium, 870 ppm by mass of oxygen, 1.6 mass % of nitrogen, and each of other impurity elements in an amount of 350 ppm by mass or less.

### Example 7

Tungsten chloride was reduced with hydrogen in the gas phase at 400° C. to obtain a coarse tungsten powder having an average particle diameter of 0.1 μm and a specific surface area of 9.6 m²/g. 20 g of tungsten powder was mixed well with a solution obtained by dissolving 0.3 g of stearic acid in 3 g of toluene to obtain a granular mixture having an average particle diameter of 160 μm. Phosphoric acid was added to the obtained granular mixture so as to allow the mixture to contain phosphoric acid in an amount of 0.05 mass %. Further, 1 g of germanium powder having an average particle diameter of 0.2 μm was added and well mixed, and the mixture was placed in a high-temperature vacuum furnace used in Example 1 and left to stand under 1×10⁻³ Pa at 1,340° C. for 40 minutes. Subsequently, after cooling the mixture to room temperature, the pressure was returned to ordinary pressure. The thus-obtained granulated tungsten powder had an average particle diameter of 180 μm and a specific surface area of 8.8 m²/g and contained 0.5 mass % of germanium, 0.3 mass % of oxygen, 300 ppm by mass of carbon, 100 ppm by mass of phosphorus, and each of other impurity elements in an amount of 350 ppm by mass or less.

### Example 8

Prior to producing a granulated powder in Example 4, a boron solution (an aqueous solution of 20 mass % of nitric acid, in which boron is dissolved so as to allow the solution to contain 0.1 mass % of boron) was preliminarily added to a coarse tungsten powder so that the boron is added in an amount of 0.03 mass % and mixed, and the mixture was left to stand under reduced pressure of 7×10² Pa at 260° C. for two hours, dried and returned to room temperature. Using the thus-treated tungsten powder, germanium was mixed with the powder in the same way as in Example 4 to obtain a granulated tungsten powder. It should be noted that the temperature of the high-temperature vacuum furnace with molybdenum electrodes was set to 1,420° C. The obtained granulated powder had an average particle diameter of 120 μm and a specific surface area of 0.2 m²/g and contained 0.5 mass % of germanium, 0.5 mass % of oxygen, 380 ppm by mass of nitrogen, 260 ppm by mass of boron, and each of other impurity elements in an amount of 350 ppm by mass or less.

### Example 9

A coarse tungsten powder was produced under the same conditions as in Example 6. The powder was left to stand under 7×10⁻⁴ Pa at 1,360° C. for 40 minutes. In course of cooling, nitrogen gas was introduced in the furnace at 1,000° C. so as to adjust the pressure in the furnace to 10 kPa and the powder was kept therein for 20 minutes. Lastly, after allowing a mixed gas of 5 volume % of oxygen and 95 volume % of nitrogen to pass through the furnace at ordinary pressure for one hour, the powder was taken out from the furnace at room temperature. Subsequently, the powder was pulverized with a hammer mill, classified with a sieve having openings of 320 μm to obtain a granulated tungsten powder. A commercially-available germanium powder (average particle diameter: 0.2 μm) was added so as to allow the mixed powder to contain 7.2 mass % of germanium powder and well mixed. The mixed powder was left to stand under 7×10⁻⁴ Pa at 1,360° C. for 40 minutes. In course of cooling, nitrogen gas was introduced in the furnace at 1,000° C. so as to adjust the pressure in the furnace to 10 kPa and the powder was kept therein for 20 minutes. Lastly the pressure in the furnace was returned to ordinary pressure with nitrogen gas and the powder was taken out of the furnace. The obtained granulated powder had an average particle diameter of 100 μm and a specific surface area of 1.6 m²/g and contained 3.6 mass % of germanium, 4.4 mass % of oxygen, 0.14 mass % of nitrogen, and each of other impurity elements in an amount of 350 ppm by mass or less.

### Example 10

At the time of producing a granular mixture in Example 7, 50 ml of water, in which 1 g of germanium powder having an average particle diameter of 0.2 μm was dispersed, was used instead of a solution of stearic acid in toluene. In a similar manner to Example 7 except that phosphoric acid was not added, a granulated tungsten powder having an average particle diameter of 180 μm and a specific surface area of 8.8 m²/g was obtained. The obtained granulated powder contained 0.5 mass % of germanium, 3.3 mass % of oxygen, and each of other impurity elements in an amount of 350 ppm by mass or less.

### Example 11

A granulated powder was obtained in the same way as in Example 8 except that a boron solution was added so that boron is added in an amount of 0.06 mass %. The obtained granulated powder had an average particle diameter of 120 μm and a specific surface area of 0.2 m²/g and contained 0.5 mass % of germanium, 1.2 mass % of oxygen, 400 ppm by mass of nitrogen, 490 ppm by mass of boron, and each of other impurity elements in an amount of 350 ppm by mass or less.

### Example 12

A granulated powder was obtained in the same way as in Example 8 except that a boron solution was added so that boron is added in an amount of 0.005 mass %. The obtained granulated powder had an average particle diameter of 120 μm and a specific surface area of 0.2 m²/g and contained 0.5 mass % of germanium, 1 mass % of oxygen, 400 ppm by mass of nitrogen, 20 ppm by mass of boron, and each of other impurity elements in an amount of 350 ppm by mass or less.

### Example 13

A granulated powder was obtained in the same way as in Example 7 except that phosphoric acid was added so as to adjust the content of phosphoric acid to 0.3 mass %. The obtained granulated powder had an average particle diameter of 180 μm and a specific surface area of 8.8 m²/g and contained 0.5 mass % of germanium, 0.5 mass % of oxygen, 300 ppm by mass of carbon, 480 ppm by mass of phosphorus, and each of other impurity elements in an amount of 350 ppm by mass or less.

### Example 14

A granulated powder was obtained in the same way as in Example 7 except that phosphoric acid was added so as to adjust the content of phosphoric acid to 0.005 mass %. The obtained granulated powder had an average particle diameter of 180 μm and a specific surface area of 8.8 m²/g and contained 0.5 mass % of germanium, 0.7 mass % of oxygen, 300 ppm by mass of carbon, 2 ppm by mass of phosphorus, and each of other impurity elements in an amount of 350 ppm by mass or less.

The granulated powder in each of examples except for Comparative Example 1 was sputtered and analyzed by Auger spectroscopy. The analysis confirmed that germanium element exists in a region within 30 nm inside the particle from the particle surface of the granulated powder.

The granulated powder in each of examples was subjected to X-ray analysis and WGe² and W⁵Ge³ as being tungsten germanide and a reaction product were detected from the particle surface region of the granulated powder.

The granulated powder produced in each of the above-described examples was formed to produce a formed body having a size of 1.8×3.0×3.5 mm. A tantalum wire having a diameter of 0.29 mm is vertically implanted in the 1.8×3.0 mm face, 2.8 mm of which is inserted inside and 8 mm of which protrudes outside the sintered body. The formed body was sintered in vacuum in the above-mentioned high-temperature vacuum furnace with molybdenum electrodes at 1,400° C. for 30 minutes to thereby obtain a sintered body of 145 mg by mass.

The obtained sintered body was used as an anode body for an electrolytic capacitor. The anode body was subjected to chemical formation in an aqueous solution of 0.1 mass % phosphoric acid at 9 V for two hours to thereby form a dielectric layer on the surface of the anode body. The anode body having a dielectric layer formed thereon was immersed in an aqueous solution of 30% of sulfuric acid to form an electrolytic capacitor using platinum black as a cathode. The capacitance and LC (leakage current) of the capacitor were measured. The capacitance was measured by using an LCR meter manufactured by Agilent at room temperature, 120 Hz and bias voltage of 2.5 V. The LC value was measured 30 seconds after applying a voltage of 2.5V at room temperature.

The results of each of Examples and Comparative Examples are shown in Table 1. The capacitance and LC values are an average of 128 pieces in each of examples.

TABLE 1

| | Germa- | | | | |
|---|---|---|---|---|---|
| | nium | | | Capaci- | |
| | content | | | tance | LC |
| | (mass %) | Content of each element | | (μF) | (μA) |
| Example 1 | 4.8 | Oxygen | 0.97 mass % | 850 | 8.3 |
| Example 2 | 0.06 | Oxygen | 1.1 mass % | 830 | 11.5 |
| Example 3 | 0.2 | Oxygen | 0.89 mass % | 880 | 5 |
| Example 4 | 0.5 | Oxygen | 0.91 mass % | 920 | 3.2 |
| Example 5 | 6.9 | Oxygen | 0.77 mass % | 710 | 11.7 |
| Example 6 | 3.6 | Oxygen | 870 ppm by | 1450 | 2.8 |
| | | | mass | | |
| | | Nitrogen | 1.6 mass % | | |
| Example 7 | 0.5 | Oxygen | 0.3 mass % | 4600 | 3.8 |
| | | Nitrogen | 300 ppm by | | |
| | | | mass | | |
| | | Phosphorus | 100 ppm by | | |
| | | | mass | | |
| Example 8 | 0.5 | Oxygen | 0.5 mass % | 900 | 3.3 |
| | | Nitrogen | 380 ppm by | | |
| | | | mass | | |
| | | Boron | 260 ppm by | | |
| | | | mass | | |
| Example 9 | 3.6 | Oxygen | 4.4 mass % | 1400 | 3 |
| | | Nitrogen | 0.14 mass % | | |
| Example 10 | 0.5 | Oxygen | 3.3 mass % | 4700 | 6.5 |
| Example 11 | 0.5 | Oxygen | 1.2 mass % | 900 | 4 |
| | | Nitrogen | 400 ppm by | | |
| | | | mass | | |
| | | Boron | 490 ppm by | | |
| | | | mass | | |
| Example 12 | 0.5 | Oxygen | 1 mass % | 910 | 3.7 |
| | | Nitrogen | 400 ppm by | | |
| | | | mass | | |
| | | Boron | 20 ppm by | | |
| | | | mass | | |
| Example 13 | 0.5 | Oxygen | 0.5 mass % | 4600 | 4.1 |
| | | Nitrogen | 300 ppm by | | |
| | | | mass | | |
| | | Phosphorus | 480 m by | | |
| | | | mass | | |
| Example 14 | 0.5 | Oxygen | 0.7 mass % | 4600 | 4 |
| | | Nitrogen | 300 ppm by | | |
| | | | mass | | |
| | | Phosphorus | 2 ppm by | | |
| | | | mass | | |
| Compar- | 0 | Oxygen | 1 mass % | 500 | 33 |
| ative | | | | | |
| Example 1 | | | | | |
| Compar- | 0.03 | Oxygen | 0.9 mass % | 620 | 40 |
| ative | | | | | |
| Example 2 | | | | | |
| Compar- | 7.8 | Oxygen | 1.1 mass % | 400 | 54 |
| ative | | | | | |
| Example 3 | | | | | |

It can be seen from Table 1 that the electrolytic capacitors of Examples 1 to 5 having a germanium content within a range of 0.05 to 7 mass % has a larger capacitance and a lower LC value compared to the capacitors of Comparative Examples 1 to 3 having a germanium content out of the above-mentioned range.

When the results of Examples 1 to 5 are compared to those of Example 10, it can be seen that the capacitance significantly increases while the LC value is kept low when the granulated tungsten powder has an oxygen content as high as about 3 mass %.

Further, when Example 13 is compared to Example 14, it can be seen that the capacitance significantly increase while the LC value is kept low when the granulated tungsten powder has a carbon content as high as about 300 ppm by mass.

1. A tungsten powder, comprising germanium element only in the particle surface region and having a germanium element content of 0.05 to 7 mass %.

2. The tungsten powder as claimed in claim 1, wherein at least part of the germanium element forms a compound with tungsten element.

3. The tungsten powder as claimed in claim 2, wherein the compound is WGe₂ or W₅Ge₃.

4. The tungsten powder as claimed in claim 1, wherein the volume average diameter of the primary particle is 0.1 to 1 μm.

5. The tungsten powder as claimed in claim 1, wherein the particle surface region is a region from the particle surface to a depth of 50 nm inside the particle.

6. The tungsten powder as claimed in claim 1, comprising at least one member selected from tungsten silicide, tungsten carbide, tungsten boride, and tungsten containing nitrogen solid solution only in the particle surface region.

7. The tungsten powder as claimed in claim 1, wherein the oxygen content is 0.05 to 8 mass %.

8. The tungsten powder as claimed in claim 1, wherein the content of elements other than each element of tungsten, germanium, silicon, nitrogen, carbon, boron, phosphorus and oxygen is 0.1 mass % or less.

9. The tungsten powder as claimed in claim 1, wherein the tungsten powder is a granulated powder.

10. The tungsten powder as claimed in claim 1, which is a powder for an electric capacitor.

11. An anode body for a capacitor obtained by sintering the tungsten powder claimed in claim 1.

12. An electrolytic capacitor, which is provided with a complex of a dielectric layer and an anode obtained by anode oxidation of the anode body claimed in claim 11, and a cathode formed on the dielectric layer.

13. A method for producing the tungsten powder claimed in claim 1 by mixing germanium powder so that the germanium element content in the tungsten powder falls within a range of 0.05 to 7 mass %, and by allowing the mixture to react through heating under reduced pressure.

14. The method for producing the tungsten powder as claimed in claim 13, wherein the heating temperature is from 1,000 to 2,600° C.

15. The method for producing the anode body for a capacitor, comprising sintering the tungsten powder claimed in claim 9.
